(19) United States
(12) Patent Application Publication
(10) Pub. No.: US 2011/0078236 A1
(43) Pub. Date: Mar. 31, 2011

(54) LOCAL ACCESS CONTROL FOR DISPLAY DEVICES

(76) Inventors: Dan R. Olsen, JR., Orem, UT (US); Richard Arthur, Provo, UT (US); Quinn Snell, Schenectady, NY (US)

(21) Appl. No.: 12/893,999

(22) Filed: Sep. 29, 2010

Related U.S. Application Data
(60) Provisional application No. 61/277,797, filed on Sep. 29, 2009.

(51) Int. Cl. G06F 15/16

(52) U.S. Cl. 709/203

(57) ABSTRACT

Access to a local device such as a display device is achieved by receiving a code that is only accessible within an enclosed space, extracting a first identifier from the code and providing a second identifier that corresponds to the first identifier to an access server. In certain embodiments, the access server is a display server.

### CROSS-REFERENCE TO RELATED APPLICATIONS

This application is a co-pending application to U.S. patent application Ser. No. 12/817,000 titled “Distributing Multiple Client Windows Using a Display Server”, application Ser. No. 12/816,992 titled “Windows Broker Server”, and application Ser. No. 12/816,984 titled “Presentation Scratch Spaces” each of which was filed for Dan R. Olsen on Jun. 16, 2010. This application also claims the benefit of Provisional Application No. 61/277,797 titled “Connection Controls for Wireless Pixels” and filed on Sep. 29, 2009 for Dan R. Olsen, Richard Arthur, and Quinn Snell. Each of these related applications are incorporated herein by reference in their entirety.

### BACKGROUND

Computers and computing systems have affected nearly every aspect of modern living. Computers are generally involved in work, recreation, healthcare, transportation, entertainment, household management, etc.

Further, computing system functionality can be enhanced by a computing system's ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Computing has become a dominant mechanism for sharing images during meetings. Many conference rooms and lecture halls have one or more projectors for displaying images that everyone in the room can see. These installations often use a VGA cable as the means for connecting personal computing devices to the shared projector in the room.

The cable may be awkward to deal with. The personal computing device is tethered tightly to the projection system allowing little or no mobility. The electrically defined protocol means that there are continual hardware negotiations on screen resolution and synchronization.

VGA connectors are usually too large for handheld computers requiring specialized adaptors or an inability to use handheld computers with projectors.

The VGA (or DVI, HDMI, S-Video) or any other video cable solution enforces a limit of at most one public screen per personal device. Complex topics may have more information than can be properly displayed on a single screen. In comparison, classrooms regularly have 40+ linear feet of blackboard space while digital presentation is frequently confined to 7-10 feet.

Typically, only a single personal computing device may have access to the projector, and thus the presentation display at one time.

Audience members typically have no access to the presentation space. Someone asking a question or offering an alternative from the audience can only speak as there is no simple provision for them to show to what they are referring.

Audience members typically have no digital access to the digital information being displayed. In particular, they cannot copy, or insert digital comments on the information being presented.

In typical VGA type scenarios, the projector displays exactly what is on the personal computing device screen. If the size of the personal computing device screen requires windows to be stacked and thus only partially visible, that same view will be seen on the presentation screen irrespective of how much space or how many presentation screens are available.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment is directed to a system for obtaining access to a local device in an enclosed space. The system comprises a client device configured to obtain a code that is only accessible within an enclosed space, wherein the code contains a first identifier that is associated with an access server; the client device further configured to provide a second identifier to the access server that corresponds to the first identifier; and obtain access to a local device if the second identifier corresponds to the first identifier. The system further includes a display server configured to provide a code that is only accessible within the enclosed space to the client device, wherein the code contains a first identifier that is associated with a display server; receive a second identifier from the client device; and enable access to the local device if the second identifier corresponds to the first identifier.

One embodiment is directed toward a method for obtaining access to a local device in an enclosed space. The method comprises providing a code that is only accessible within the enclosed space to a client device, wherein the code contains a first identifier that is associated with an access server. The method further comprises receiving a second identifier, and obtaining access if the second identifier corresponds to the first identifier, wherein obtaining access verifies that the client device is present.

One embodiment is directed toward a method for obtaining access to a local device within an enclosed space. The method comprises obtaining a code that is only accessible within the enclosed space, wherein the code contains a first identifier that is associated with an access server. The method further comprises providing a second identifier to the access server; and obtaining access if the second identifier corresponds to the first identifier, wherein access verifies that the local device is present.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a display server architecture;

FIG. 2 illustrates an alternate display server architecture;

FIG. 3 illustrates spreading windows at a display server;

FIG. 4 illustrates another example of spreading windows at a display server;

FIG. 5 illustrates a display server architecture within an enclosed space and a client device outside the enclosed space;

FIG. 6 illustrates a shared display space system;

FIG. 7 illustrates a method for a client device to receive presence verification within an enclosed shared display space; and

FIG. 8 illustrates a method for providing presence verification to a client device within an enclosed shared display space.

### DETAILED DESCRIPTION

Some embodiments described herein enable personal computing devices to annex display services over a network rather than a video cable. Network-based display services provide many new possibilities for shared use of digital display space.

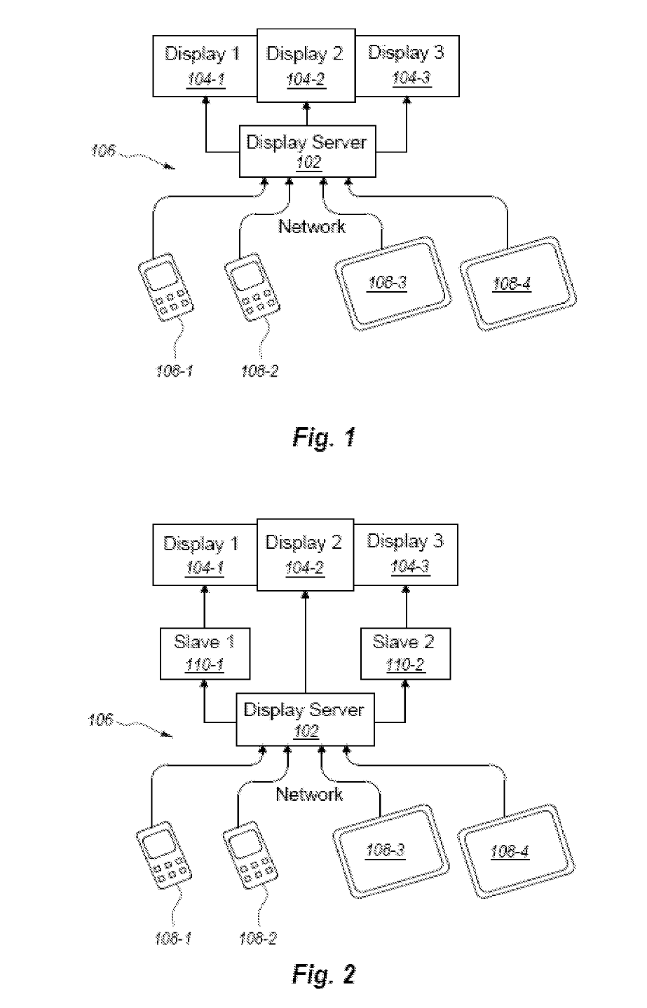

Referring now to FIG. 1, an access display server architecture 100 is illustrated. In particular, FIG. 1 illustrates an access and/or display server 102, which is a computing device attached to (which may be referred to herein as including), one or more devices 104-1, 104-2 and 104-3 (referred to herein generically as 104). The devices 104 may be display devices. The display server 102, in some embodiments, has complete control over drawing on the attached displays 104. The hardware implementation of this attachment may be accomplished in any one of a number of different fashions, including wired video connections such as one or more of VGA, DVI, HDMI, S-Video, component video, composite video, etc or wireless video connections. Various geometric arrangements of the displays relative to each other may also be used. However, it is useful for the display server 102 to know what arrangement is use and to be able to effectively access pixels displayable by the displays 104 in a uniform coordinate system.

Display servers 102 may be installed at a particular location. Such installations may be a classroom, a conference room, a team working room, a presentation hall or a personal office space. Server software runs on the display server 102. The display server 102 may be connected to a digital communications network 106. Software creating displayable subject matter to be displayed by the display server 102 may be running directly on client devices 108-1, 108-2, 108-3 and 108-4 (referred to herein generally as 108) possessed by the users, such as participants or presenters of a meeting. Client devices 108 may be portable and may include handheld computers, cell phones, tablets, or laptops or any other appropriate computing device. Client devices 108 may annex a display server 102 for the purpose of showing information on that display server 102. These images may be static images stored on the client device 108 or on some other storage device accessible to the display server 102 over the network 106. Alternatively, the images may be more dynamic in nature in that they are produced by playing videos stored on the client device 108 or some other service. Alternatively, these images may be generated by continually distributing graphical information from applications running on a client device 108 to the display server 102. The content being presented is typically under the control of a client device 108 with the display server 102 merely visually presenting the content. Audio content may also be presented in similar fashion.

More than one client device 108, as illustrated in FIG. 1, may annex a display server 102 at any given time. Mechanisms, as described below in more detail, may be provided to control this sharing of the display service.

Communication between the client devices 108 and a display server 102 may be in terms of a presentation control protocol (PCP). It is through this protocol that client devices share presentation information and provide control over that presentation.

It may be useful to in some embodiments to implement a presentation control protocol that is relatively static. That is the protocol remains relatively unchanged. Any user carrying a client device 108 that implements the PCP will be able to use any display server 102 that they encounter. This allows users to nomadically carry their computing in their personal client devices 108 and use display resources freely as they find them. This also means that the interactive techniques or services for using display services are implemented in the user's client device 108. By using a static protocol, users would not need to relearn how to control or use each display service that they find. They bring their user interface, as implemented by their client device 108, with them and it works regardless of the display server 102 implementation. This is facilitated by a static, or infrequently changed, PCP. Client devices 108 can implement any interactive style that they choose and it works on a display server 102 compliant with the PCP.

While in alternative embodiments the PCP is less static, this may require updates to client devices that wish to use the display server, depending on the changes that are made to the PCP implemented at the display server. While PCP changes may inevitably occur, by concentrating on display related functionality in the display server the number of PCP changes can be limited. Therefore an architecture that focuses on putting user interface and control functionality into clients, while minimizing or eliminating such controls at the display server will create a more functional and dynamic system.

As illustrated in FIG. 2, the display server 102 may be implemented using multiple computing devices. Each computing device controls one or more displays 104 or in some embodiments, display regions, which are regions not necessarily bounded by an entire display. Rather a display region may be a portion of a display including less than all of the display, or in fact may be portions of two or more displays. There is a master display server 102 that accepts client device 108 control requests and forwards them to the appropriate slave server(s) 110-1 and 110-2. From the perspective of the client devices 108 the architecture is the same as that illustrated in FIG. 1. Only the display server 102 implementation is different. The same PCP can be used either for both the architecture illustrated in FIG. 1 and the architecture illustrated in FIG. 2.

The following are example scenarios for how these architectures may be used in practice. In a first example, a presentation scenario is shown. In this scenario, a person brings their personal client device 108 into a room that contains one or more displays 104 controlled by a display server 102. They establish a connection to the display server 102 by means of a user interface implemented on their client device 108. They then proceed to use any or all of the displays 104 to present information stored on either their client device 108 or some other service available over the network 106 (or some other network, such as an external wired or wireless, cellular, or other network).

Another example includes a moderated meeting scenario. In this example, there may be a room where several presentations are to be made. A moderator for the meeting enters the room and annexes the display server 102 from his personal client device 108 using whatever user interface is implemented on his client device 108. Various presenters also enter the room and annex the display server 102 using their client devices 108. The moderator has control of the display server 102 and may dictate the information that each of the presenters is allowed to show on the shared displays 104. The moderator may also dictate when each of the presenters is allowed to show information from their client devices. The control of who may show what and when is provided through a user interface implemented on the moderator's personal client device 108. The user interface provided on the moderator's device need not correspond to any of the user interfaces on the presenters' client devices 108. Each participant controls their own information using their own familiar tools on their own devices. The display server 102 merely enforces the control exerted by the moderator's client device 108.

The following scenario illustrates an example where audience participation is facilitated. Whether there is a single presentation or a moderated meeting there may be an audience present. Some of the audience members may posses their own client devices 108. The audience members can annex the room's display server 102 as watchers rather than presenters. A watcher has the privilege of requesting a digital copy of whatever is being presented on the shared displays 104. The display server 102 will take a copy of whatever is being displayed and return it to the watcher's client device 108. The watcher can then use that image as part of note taking or insert the image into other data using other client device software on their client device 108.

At some point in the presentation a watcher may have a question about a previous point in the presentation. They can then repost any images that they copied from the presentation or new material of their own to illustrate their question. Their ability to post is controlled by the moderator or the presenter if there is no moderator. The moderator's user interface for controlling the conversation is on his own device and independent of the implementations on any of the other client devices 108.

The following scenario illustrates an example where discussion is facilitated. A discussion may be where several people attend a meeting in a room with a display server 102. Each of them brings a personal client device 108 with whatever information or applications that they desire. Each annexes the room's display server 102. Each may use the display server 102 to post information or application instances to one or more displays 104 that they feel are relevant to the discussion. Depending on the size of the group, the amount of shared display space and the nature of the task, there are various ways in which the display space may be managed. One way is for each participant to have the right to move anything around anywhere. This is a free form style that works with cooperative teams and where social norms rather than software rules are effective. It is also possible to allow each user to control their own material but not that of anyone else. The problem is who will decide what to do when material from two different users overlaps. The group may be formal enough that it facilitates a moderator who controls what is presented and when it is presented. Thus, embodiments may be implemented where individuals in the room can contribute information to the shared display space and all control models are not necessarily hardcoded into a display server 102 implementation, but rather some human moderated control is allowed.

The following scenario illustrates an example where personal use is facilitated. Display service architectures may also be used by a single individual. A personal workspace may be populated with several display devices. The user enters his workspace with a personal client device 108 that then annexes the display server 102. The user may now use all of the presentation space for their own purposes and then take it all with them.

The following now illustrates various techniques for distributing graphics. Embodiments may include the ability to distribute graphical information over a network from a client to a display server 102. Discussed herein are three basic mechanisms for this distribution: 1) pixels, 2) draw commands and 3) display lists.

Some pixel mechanism embodiments are the most general because they depend solely upon the pixels being displayed with no dependence on the operating system, graphics toolkit or the applications being run. A region of the client's display frame buffer is designated as being shared with the display server 102. Periodically a process in the client device 108 samples all of the pixels in that region and ships them to the display server 102 who paints them in an appropriate location on one of the displays 104. In some embodiments, efficiencies can be obtained by first comparing the pixels just extracted from the frame buffer to pixels previously sent out. Only the differences are sent. This can sharply reduce the demand for network bandwidth. There are potentially other algorithms that can be used to reduce the bandwidth required for distributing pixels. Pixel distribution, while expensive in terms of client CPU load and network bandwidth, is useful at least in that it can be at least somewhat independent of whatever graphics model, operating system or user interface toolkit is implemented on a client device 108.

The draw commands distribution approach involves capturing the drawing calls made by applications (draw line, draw ellipse, draw text, etc.), serializing the parameters of those calls and then forwarding them to the display server 102. The display server 102 then executes those draw commands in the same fashion as they would have been implemented on the client device 108. Embodiments of this approach can be cheaper in terms of client CPU usage because there is no need to examine all the pixels for changes. Further, some of these embodiments may take less network bandwidth than the pixels technique. In some embodiments using this technique, drawing models of both the display server 102 and all client devices 108 are identical.

The display lists distribution approach is an efficient technique. A data structure built of draw commands is created by the application and shared with the drawing subsystem. The application changes the data structure and the drawing system redraws the content in that structure. In terms of distribution, in some embodiments, only the changes to the display list (generally very small) need be serialized to the display server 102. This conserves client CPU time and network bandwidth.

Some embodiments described herein may use any one of these three techniques, while other embodiments may be limited to only one of the techniques.

Screen space may be controlled by window management software. This software breaks the display into independent regions (windows) that may or may not overlap. Window management allows users to move windows around the screen, change which windows are on top, resize windows, close windows and iconify windows to put them out of the way. There are a variety of styles, from the “cluttered desktop” model found on many personal computers, tiled layouts, styles that prevent overlap by resizing and styles that can “zip” windows together so that they can be manipulated as a unit.

Using the standard VGA approach to presentations there is no need for a window management solution. The client device screen is duplicated on the projector and whatever window management is running on the client device also runs on the projector. There is only one user/computer involved so there are no additional management responsibilities. However, in some embodiments outlined herein, window management is taken into consideration. In particular, by untying presentations from the standard VGA approach, windows management becomes more pertinent to the implementations. Some embodiments may address windows management issues related to users making a presentation using multiple screens such that there is more screen space for the presentation than there is space on the presenter's device. This means that traditional window management techniques running on the client device 108 may not map directly to the windows management of the display server 102.

Some embodiments may address windows management issues related to providing a presenter with familiar windows controls. Additionally, some embodiments may address issues related to traditional window management. For example, many traditional systems are based on fine-precision mouse manipulation. One may not want to do those things in the middle of a presentation. One may wants to focus on the presentation. Thus, some embodiments may implement features with different window management techniques.

Some embodiments may address windows management issues related to allowing each presenter to have their own model of how they want to use the presentation space. Some embodiments may provide presenters the opportunity to use their own tools. Some embodiments may implement features to address the role of a moderator. Some embodiments may include functionality to allow the moderator, not any of the presenters, to control the visibility of windows.

Some embodiments may address windows management issues related to audience participation. When the audience begins to participate in the presentation the window management problem becomes more complex. When each audience member has their own client devices 108 and tools it may be difficult to impose restrictions on the client devices 108. Frequently audience members will be working from handheld devices with even less screen space for window management. Some embodiments may address some of these issues by allowing a presenter or moderator to retain control of items that may appear on a display 104 and their ultimate disposition.

Some embodiments may address windows management issues related to discussions. A discussion generally occurs among people who are working together for a common goal. As such, many of the control issues may be relaxed relative to a presentation experience. There are now many users displaying their data on a screen 104. There are a variety of ways in which control might be exerted and a variety of ways in which software might facilitate the management of the space. In discussion scenarios there may be many screens (e.g. 10 or more) with information displayed all around the room. In some embodiments implemented in these types of scenarios, window management, rather than being managed by a single individual, may be distributed among the participants.

Some embodiments may also address issues related to access control. In particular, it may be useful to provide control over who may present and where. Even a single presenter may have use for a mechanism to take control of the display 104 from client devices 108 or individuals that may have been using it previously. When there is audience participation there may be use for mechanisms to control who may put things up on the screen and possibly preview what they will display. In a discussion there may be use for policy about who may move what things around the display space, where they may put them, whose things an individual may move etc. In some embodiments, these access controls and policies are not built into the server, but rather a general architecture for access control with the ability for one or more client devices 108 to provide users with that access control may be implemented.

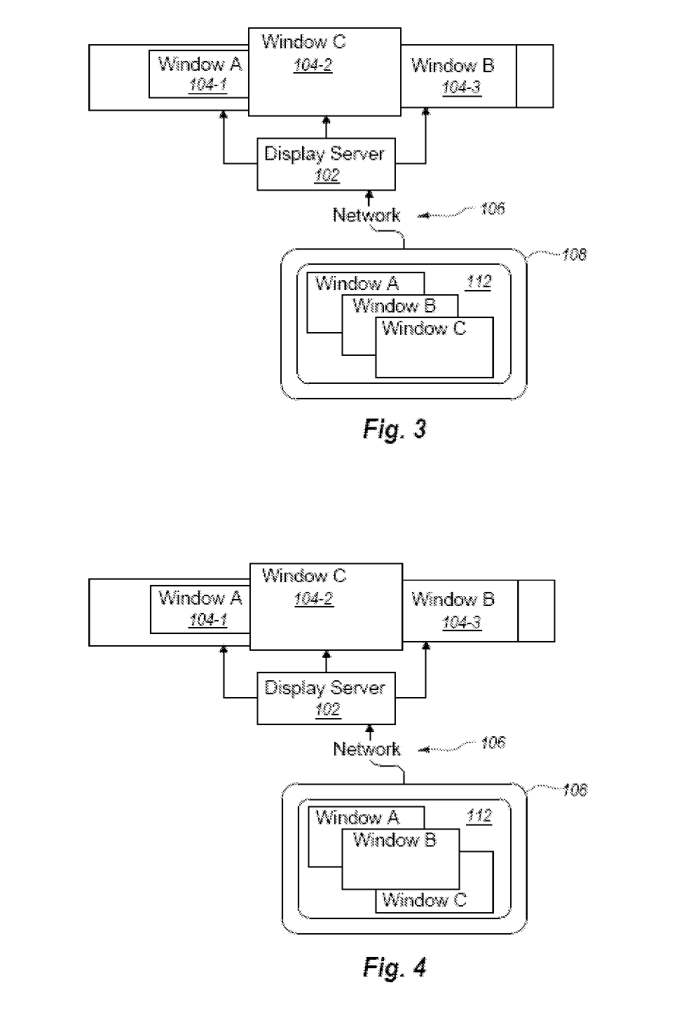

Referring now to FIG. 3, an embodiment is illustrated that uses pixel-based distribution and controls pixel copying based on which window is on top on a user's client device 108 display. Pixel-based distribution of graphics involves capturing a segment of pixels from a frame buffer and distributing them to a display server 102 for presentation on one or more displays 104. By definition, this distribution of pixels is not larger than the screen space available on display 112 of the client device 108. However, there are many situations where the display server 102 has much more screen space available than the client device 108. Embodiments may take advantage of this by using window information to translate the overlapping windows (windows A, B, and C) on a client device 108 into a spread out configuration on the displays 104-1, 104-2, and 104-3 (as shown in FIG. 3). This may be particularly valuable on handheld devices where the common window management technique is to show only one window at a time.

In the example shown in FIG. 3, on the client device 108, windows A and B are obscured and their content cannot be seen or is only partially visible. However, at the display server 102, all of windows A and B are visible on the displays 104-1 and 104-3. This may be accomplished by controlling the streaming connection between a window on the client device 108 and a window on the display server 102.

A desktop (or portable device) windowing system may provide system calls that will provide the following information: (1) the location, size and front-to-back ordering of all windows on the desk top; and (2) a unique identifier for each window. In some embodiments there is a “current window” on the client device 108 that is being streamed. In the example shown in FIG. 3 this is window C. In some embodiments, only the pixels in the region controlled by the current window are captured for distribution to the display server 102. Before each pixel capture, the client software checks with the windowing system to see if the current window has any other windows in front of it. If not then the pixels of the current window are distributed to the display server 102 (Window C in FIG. 3). If there is another window in front of the current window, and the other window in front of the current window is a distributed window (i.e. is intended to be distributed to the display server 102) then pixel capture on the current window is terminated and the new front window becomes the current window. If the new front window is one that it is being distributed, then its pixels are now captured and distributed to the display sever 102. An example of this new situation is illustrated in FIG. 4 where Window B is the new current window. The last captured pixels for windows A and C are still displayed, but they are not currently being captured by the client device 108 and updated at the display server 102.

However, as illustrated below, alternate embodiments may be implemented where pixels for windows A and C may continue to be captured at a client device 108 and stored in an off-screen memory at the client device. The pixels may then be sent to the display server 102.

The unique id of each client window is associated with a window on the display server 102. This allows for the clean connection between client windows and their surrogates on the display server 102.

Thus, embodiments may be implemented to use pixel-based distribution to expand overlapping windows on a display 112 of a client device 108 to be separate non-overlapping windows on displays 104 of a display server 102, thus expanding the display ability of the client device 108.

Some embodiments may be implemented such that when there is a non-distributed window that overlaps the current window, the privacy of the non-distributed window may be protected by blocking the transmission of pixels of the non-distributed window. In particular, a non-distributed window is one that should not be distributed to the display server. For example a user at the client device 108, or policy at the client device itself, may determine that a particular window should not be distributed to the display server. In one embodiment, the non-distributed window may be an alert message or a file dialog box that provides no real useful information for meeting participants and thus should not be distributed. For example, the non-distributed window may include information about a client device 108 and/or its files, such as might be shown in a file dialog box. In other embodiments, the window may simply include information that a user does not want shared.

In some embodiments, when a non-distributed window overlaps a distributed window, the privacy of the non-distributed window may be protected by blocking the transmission of only those pixels of the distributed window overlapped by the non-distributed window, as well as the pixels of the non-distributed window. The other pixels of the distributed window continue to be captured and transmitted.

In some embodiments, when there is a non-distributed window that overlaps the current window, the privacy of the non-distributed window may be protected by taking the pixels of the current window that were captured before overlap and modifying them by blending them with some highlight color. In one embodiment, the highlight color may be gray. These modified pixels are distributed to the display server 102 to show that those pixels are not currently being updated. The pixels of the non-distributed window overlapping the current window are then blocked. Once the non-distributed window is moved or no longer in front of the current window, the pixels of the current window previously overlapped are once again available to send to the display server 102.

In one embodiment, information about non-current windows may be stored in an off-screen memory at the client device 108. This information may then be sent to the display server 102 where it may be displayed. Thus, in this example, there is a first window that overlaps a second window on the display at the client device 108. Whenever the information to be display in the second window is updated, that information is graphically-rendered, including any overlapped region, to an off-screen image memory. At least some pixels in the off-screen image memory are not displayed at the client device 108. The off-screen image memory is then used to transmit the pixels of the second window to the display server 102. In this embodiment, the windows displayed at the display server 102 may be current even for windows that are obscured at the client device 108.

Some embodiments may address windows management issues related to verifying that the client device is present in the room. More generally, the verification may be done for enclosed spaces. This is important because it provides an assurance that information being shared is only from individuals present in the room. Present individuals typically adhere to social conventions that dictate appropriate behavior. On the other hand, individuals that are absent may more readily engage in malicious behavior without regard to social consequences. Such behavior may include the following: presenting inappropriate materials, disrupting presentations, exerting inappropriate control over windows and displayed information, and copying material from the display that was intended for private consumption. Other types of unwanted behavior may be manifested as well. Thus, verification of presence also provides an awareness of who may be responsible for any inappropriate behavior during a meeting. Furthermore, the verification of presence provides an assurance that the people in the room may trust that their displayed information may only be viewed by other individuals that are also present in the room. Therefore, the decision on whether or not to share information may be based, at least in part, on this trust of confidentiality provided by the verification of presence.

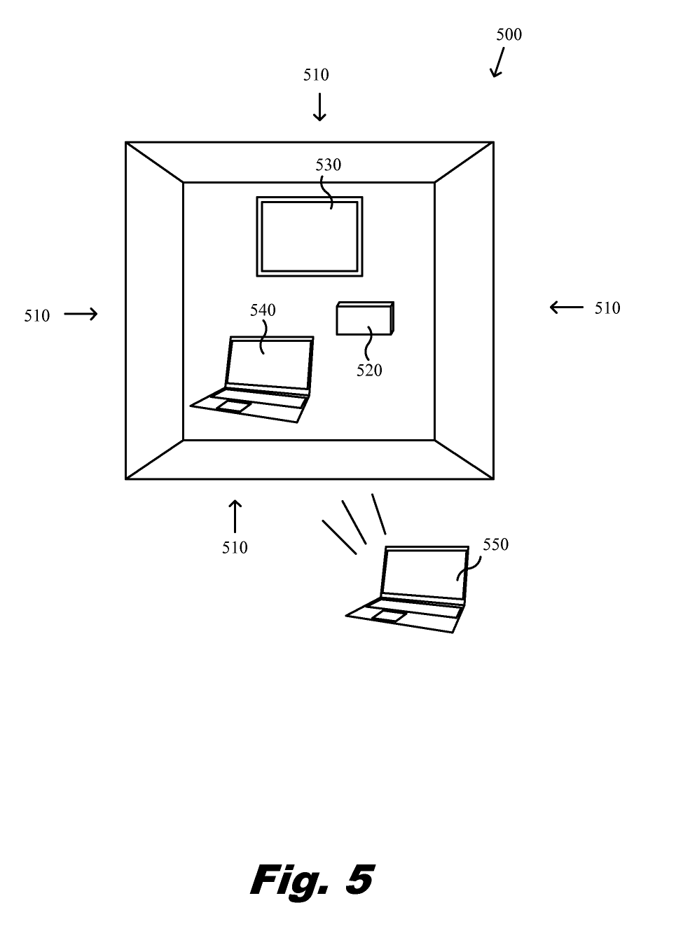

FIG. 5 depicts an enclosed space 510, in which a shared space environment includes an access and/or display server 520, a local device 530, and a client device 540. The local device 530 may be a display device 530. All other elements and features that may be used for an access and/or display space architecture 100, such as elements and features provided herein, may be also be included in the enclosed space 510. As shown, an intruder client device 550 is located outside of the enclosed space 510. The intruder client device 550 may try to enable access with the display server 520 and obtain access to devices within the space 510 but cannot through the access control methods described herein.

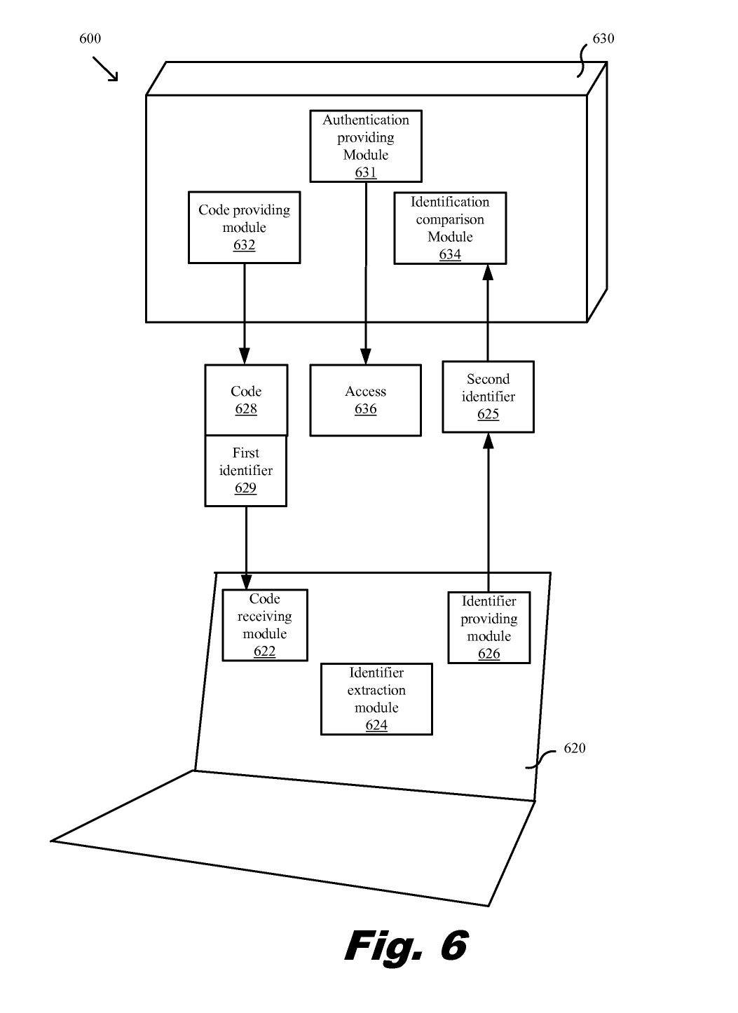

In some embodiments, the verification of presence and the enabling access may be accomplished by means of code verification. FIG. 6 depicts a verification system using a display server 630, comprising a code providing module 632 and an identifier comparison module 634; and a client device 620, comprising a code receiving module 622, an identifier providing module 626, and an identifier extraction module 624. A code 628 is provided by code providing module 632, the code being only accessible within the enclosed space. The code may only be obtained by the client device 620 if the client device 620 is present within the enclosed space. In this manner, an outside client cannot obtain the code 628.

In some embodiments, the code providing module 632 provides a code 628 containing a first unique identifier 629 to the client device 620. The client device 620 receives the code 628 including the first unique identifier 629 in the code receiving module 622. The first unique identifier 629 is then extracted by the identifier extraction module 624. A second unique identifier 625 is provided by the identifier providing module 626 to the identifier comparison module 634. If the second unique identifier 625 corresponds to the first unique identifier 629, then an authentication providing module 631 provides authentication 636 that the presence of the client device within the enclosed space has been verified.

In some embodiments, the modules are controlled, communicated, and operated by a moderator to provide and receive the codes 628, identifier 629 and 625, and the authentication 636. In other embodiments, the display server 630 or the client device 620 makes requests to receive such things.

In other embodiments, the client device 620 performs the verification process by sending its own first unique identifier 629 in a code 628 and receiving a second unique identifier 625 from the display server 630. The comparison between the first 629 and second 625 identifiers and subsequent authentication 636 may be performed by the client device 620.

In some embodiments, the code providing module 632 displays the code 628 as a visual code containing a first unique identifier 629 within the enclosed space. Alternatively, another display device displays the visual code 629. The client device 620 may initiate the offering of the second unique identifier 625 to the display server 630 or the display server 630 may initiate a request to receive the second unique identifier 625. Having received the second unique identifier 625 from the client device 620, the display server 630, or another entity, compares the second unique identifier 625 with the first unique identifier 629. If a match is found between the first 629 and second unique identifier 625, presence of the client device 620 may be verified. Alternatively, the client device 620 may provide the second unique identifier 625 to another entity to receive verification.

In some embodiments, the code 628 may contain the first unique 629 identifier such as a an Internet protocol (IP) address, an Internet Domain name or some other identifier appropriate to the network being used to communicate between the client device and the display server. The code 628 may contain the first 629 unique identifier in isolation, or the code 628 may comprise additional information susceptible to encoding.

In some embodiments, the first unique identifier 629 is encoded as a bar-code or some other visual encoding of binary information. The visual code 629 may be displayed prominently in the room where it may be seen by a camera mounted on the client device 620. The client device 620 may take a picture of the visual code and convert the image into the first unique identifier 629. Another variation of a visual encoding is a visual code that may be attached to a desk, arm, seatback or table where participants may be seated. This variation is beneficial because it is less prominent and therefore, less visually distracting, than a display from a large bar-code. Although a less prominent code may be displayed, the picture of the code may still be easily taken by the camera or other sensing device to obtain an image.

Alternatively, the code 629 may be encoded in a radio frequency identifier (RFID) tag that is attached or coupled with the client device 620. Upon entering a room, the room's RFID reader reads the tag and notifies the display server 630 of its information. The display server 630 then contacts the client device 620 to inform it of the first unique identifier 629 of the display server and thus initiate the verification process. The verification process may then proceed as depicted in FIG. 6.

Contacting the client device 620 need not distract the participant with the notification. Rather, when the participant is ready to receive presence verification and display device access, the participant may view a list of display servers that have receipt of the RFID tag information. The participant may then select the desired display server in the list and the display server 630 may verify the client 620.

In other embodiments, the participant may select whether to be contacted about the presence of a unique identifier, the presence of a certain unique identifier, or the presence of a unique identifier at a certain time or location. Further preferences may also be defined by the participant and the display server 630.

In another embodiment, an infrared emitter may be used to periodically broadcast the unique identifier of the display server 630. This may use any number of IR transmission protocols with the signal confined to the enclosed space. In this manner, the signal is prevented from being captured from outside the enclosed space.

The presence of participants may also be validated through the use of image verification. For instance, a database of images may be maintained which are capable of being displayed on a client device. When the display server 630 desires to validate the presence of a client device 620, it may randomly select a set of images from the database to send to the client device. Subsequently, the set of images are displayed on the client device 620. The display server 630 also selects one of the images and displays it on the screen of the display server 630. From the set of images displayed on the client device 620, the participant selects the image that corresponds to the image on the screen of the display. The display server 630 then verifies the presence of the client device 620 if the image selected by the participant corresponds to the image on the screen of the display server 630.

In certain embodiments, multiple images are placed in a certain order on the screen of the display server 630. The client device 620 is then given an array of images and the participant is prompted to order the images. When the participant orders the images in the same order as the image order on the screen of the display server, presence verification may be confirmed.

In some embodiments, the presence of the client device 620 may be validated using light-based beacons that emit light encoded with the first unique identifier 629. Although a preferred mode is the infra-red spectrum, any light spectrum may be used. For example, in one embodiment, a light signal is modulated using standard techniques, such as those found in television remote controls or IRDA devices. Visible light may be used if the code 628 is modulated into the light signal at higher than 60 times per second in which case the client device 620 has a light receptor capable of interpreting the light-based transmission. The client device 620 may receive the code 628 in the light-based transmission and forward the second unique identifier 625 contained within the code 628 to the display server 630. The display server 630 compares the second unique identifier 625 from the client device to the first unique identifier 629 encoded within the light-based transmission. Presence verification of the client device is given if the forwarded second unique identifier 625 corresponds to the first unique identifier 629 in the light-based transmission. If the comparison does not yield a match, the client device 620 may still receive a subsequent code from the light-based transmission and make another attempt to receive presence verification. The subsequent code may be the same as the former code. Alternatively, the code may be different. In some embodiments, the code may be broadcast intermittently, for instance, every 1-3 seconds. Alternatively, the code may be broadcast continuously and received by the client device 620 except when the connection is denied or broken by the server. This latter technique is advantageous because it minimizes the computational effort on the client device 620.

In order to prevent line of sight problems for a client device 620 to pick up the light-based signal, multiple beacons may be placed in the enclosed space, each synchronized to identical signals.

The code 628 may be changed periodically, by the moderator or an automatic setting. In some embodiments, this change forces the client device 620 to revalidate its presence by forwarding the new second unique identifier 625 to the display server 630.

In some embodiments, the validation process is invisible to the user, meaning that user involvement is not necessary and that the validation operations discussed are carried out automatically between the client device 620 and the display server 630. Periodic revalidation will cause the client device 620 to lose the verification if the client device 620 leaves the enclosed space and is absent while the code 628 is changed. Losing verification upon leaving an enclosed space, however, may be prevented. For example, user intervention may prevent loss of verification. Also, the display server 630 may only require verification a set number of times. The possibility of losing verification upon leaving the enclosed space serves to enforce the notion that only the client device 620, and thus the person in the enclosed space, may have access to what is being displayed in the enclosed space.

A pen-based gesture is another example of the type of code 628 that may be used to validate the presence of the client device 620 to the display server 630. Pen-based gestures are used, for example, by the Palm OS Graffiti system, which displays an alphabet stroke guide that may be followed by a user to make alphabet strokes that will be recognized by the Palm OS Graffiti system. Such strokes, or gestures, may be made with a pen or stylus. The visual form of the gesture representation may vary as long as users understand how to translate that representation into the appropriate pen or stylus stroke.

In embodiments, pointing inputs may be generated using an accelerometer built into the client device. For example, the client device 620 may make the stroke by holding down a button and waving the client device 620 in the air in a pattern consistent with the displayed stroke. After ending the stroke, the button may be released and the stroke may either be reduced to features and the features then sent to the display server 630 or the raw accelerometer data then sent to the display server 630 to be checked for validity.

Alternatively, the user may make the gesture with an input device such as a pen, stylus, or mouse. Also, human movement may be used instead of an input device. For example, finger movement on a mousepad or other sensory pad may be used to make the gesture. Also, body movement may be sensed by a camera on the client device 620.

In one embodiment, the screen of the display server 630 displays the visual form of the gesture representation. The gesture may be selected from a set of gestures. Also, the selection of the gesture may be random. Alternatively, the gesture may be selected in a prescribed order from a set of gestures. The display server 630 may then apply one of many possible gesture recognition algorithms to verify that the user has provided the appropriate gesture. This embodiment has the advantage of not requiring the client device to have a feature generation algorithm that is compatible with the algorithm on the display server 620. The raw inputs may be sent and the matching algorithm may be completely contained within the display server 630.

In an alternative embodiment, the screen of the display server 630 may display the visual form of the gesture representation to the moderator or another person in the room. The gesture representation may then be drawn on a whiteboard or other visible surface in the room. Any mechanism that provides a visual guide for making the appropriate gesture may be used for this technique to be effective. Furthermore, this alternative may provide a technique that is simpler and less costly than having the display space be used.

In embodiments, the sequence of inputs generated by the user is sent to the display server 630. The display server 630 then applies one of many possible gesture recognition algorithms to verify that the user has entered the appropriate gesture. This method has the advantage that the client device 620 does not need to have a feature generation algorithm that is compatible with the algorithm on the display server 630. The raw inputs are sent and the matching algorithm is completely contained within the server.

In further embodiments, a feature generation algorithm is used to recognize a gesture by both the display server 630 and the client device 620. The input sequence from the user is run through the feature generation algorithm to generate a vector of features. This vector of features may then be sent to the display server 630 to verify that the appropriate gesture was entered. The technique of using a feature generation algorithm has the advantage of sending less information as part of the verification process.

The examples described to locate the unique identifier may be used in conjunction with each other or used by themselves. Also, the examples described may be used in conjunction with other existing techniques.

Advantageous to the use of code verification in which the code 628 is presented only within an enclosed space is that it protects against the malicious observance of the code 628 from outside the enclosed space. Of course, a piece of software may be written to generate all possible codes. With a fewer number of characters, the number of possible codes is shortened, and hence the time required to try all possibilities is shortened as well. Embodiments may address this challenge by setting a limit of the number of entry tries that may be allowed. Additionally, the number of possible codes may be increased.

An outsider with the ability to observe network traffic may watch for the validation messages and codes. It is possible that an observed validation message or code may then be duplicated by the outsider. To prevent this type of occurrence, an encryption technique may be used for securely passing messages over a network. For example the codes sent by the display server and the unique identifier sent by the client device may be encrypted.

If the presence of the client device 620 is verified, access and privileges may be granted. For instance, permission to archive all or a portion of the shared information may be granted. Archival may further include of all information that has been displayed, information that is currently being displayed, and information that will be displayed. With permission granted, the client device 620 may select all or a portion of the shared information for the desired amount of archival. In making selections or granting or denying permission, the client device 620 and the display server 630 may communicate with each other, for example, by sending messages, message cues, or other types of signals. Also, the display server 630 may return graphics that represent the information that is currently displayed on the screen or in a specified region of the screen.

The archival of shared information may comprise a time stamped archive of all shared information presented by the display server 630. The archival may further make it possible for participants to obtain digital copies of the archived material.

One way of archiving display server 630 information may include periodically saving “frames” of information being displayed. In embodiments, a segment of the shared information is archived and may be referenced through an offset from an initial reference point of the shared information. This offset may be represented as the time elapsed from the beginning of the archive, a number of frames from the beginning of the archive, or by some absolute time reference. A range of frames may be archived by specifying two offsets, with the archived information being the information between the two offsets. By referencing the archive, participants may obtain digital copies of currently or previously displayed shared information.

In another embodiment, the client device 620 may be associated with a moderator that exerts global control over archiving. In some cases, the client device 620 may become the moderator. In some embodiments, the moderator may permit or block the ability to archive information and may also control the storage location of the archive on the display server. Moreover, the moderator may communicate with the display server 630 regarding the information related to the archival.

In embodiments, the moderator may selectively grant permission of archive access activity to the particular client device 620 by verifying that the client device 620 is on a list or associated with a user specified in a list of known participants. This list may be provided by the display server 630, the client device 620, or another source. The moderator may also select the particular client device 620 to receive archive activity, with no regard to the list.

Another privilege that may be given to the client device 620 as a result of having its presence verified is the privilege to mark shared information that is susceptible to archival or that has already been archived. The mark represents a particular time of importance in the archive and is stored with the shared information in the archive.

The mark may include an identifier of the archive repository, such as a URL, along with a time or display frame offset from the initial reference point of the shared information. The mark may contain other identifying information such as a text description and identity information of the participant requesting the mark.

Some embodiments include the display server 630 providing the mark with the desired offset or range encrypted in a secure credential. When this secure credential is sent to the archive, the offset or range is decrypted and used to access the appropriate frame or region of frames in the archive. This credential allows access to a portion of the archive without verifying the identity of the user. Any of a variety of encryption techniques may be used for encrypting and decrypting the offset and credential to verify that the client device 620 is able to access a particular part of the archive. In further embodiments, the client device 620 may obtain the mark with a credential pertaining to the client device to verify that the client device 620 is able to access a particular portion of the archive.

If the client device 620 belongs to a known participant, then the mark may be associated with that participant. The mark may be saved as part of the archived shared information, and may serve to indicate an important or relevant point of the shared information. Furthermore, the mark that comprises information associated with the client device 620 may be used in isolation, or in conjunction with the unique identifier contained within the code, to verify the presence of the participant. Also, the mark may be used to verify the participant in order to grant archival privileges.

In some embodiments, the client device 620 may send a request to the display server 630 to save the current information in the archive stream. This may be done with a mark or an offset on the current information. The request may be approved manually by the moderator if desired. The display server 630 may return graphics that represent the information currently being displayed on the screen. If approved, or if no approval is necessary, the information may then be stored on the client device. The offset and mark may also be stored on the client device.

Also, the moderator may control where the mark is saved, such as on the display server 630 or on the client device 620. The display server or the moderator may forbid such marks by any client device that has not previously validated presence in the room. This prevents spurious cluttering of the archive by persons that are not present.

In some embodiments, placing a special no copy symbol in displayed material may be used by the display server 630 to forbid capture or archiving. This symbol may be a small image that has been specified by the moderator or optionally by the client device 620 for its own presentations. When the display server 630 receives any of the capture or mark request messages, it may check the captured images to see if the no copy symbol appears in any of the requested capture or mark. If the symbol does appear then the request may be denied. The use of an image symbol may allow applications that are not implemented with the server protocol in mind to still protect their material by inserting the image.

As depicted, a local device access method 700 includes accessing 710 shared information, obtaining 720 a code, extracting 730 a first identifier, providing 730 a second identifier corresponding 760 to the first identifier, and obtaining 770 access.

Obtaining 710 shared information may include access to information on the screen of the access server 630. Obtaining 720 a code may include the client device 620 obtaining the code 628 that contains the first identifier. If no code is received, the client device 620 continues to access shared information and remains in a waiting position to receiving the code. Once a code has been obtained, however, the client device will extract the first unique identifier 629 from the code 628, and as discussed in embodiments presented herein.

Providing 740 the second identifier may include the client device providing a second unique identifier 625 which corresponds to the first unique identifier 629 to the access server 630. Once received, the access server attempts to find a correspondence 760 between the first 629 and second 625 identifiers. If no match is found, the client device 630 must receive another code 720. If a correspondence exists, however, obtaining 770 access to the client device may be performed, which verifies the presence of the client device 620. These operations may be repeated as described in embodiments, as desired by the moderator, or in accordance with other procedures.

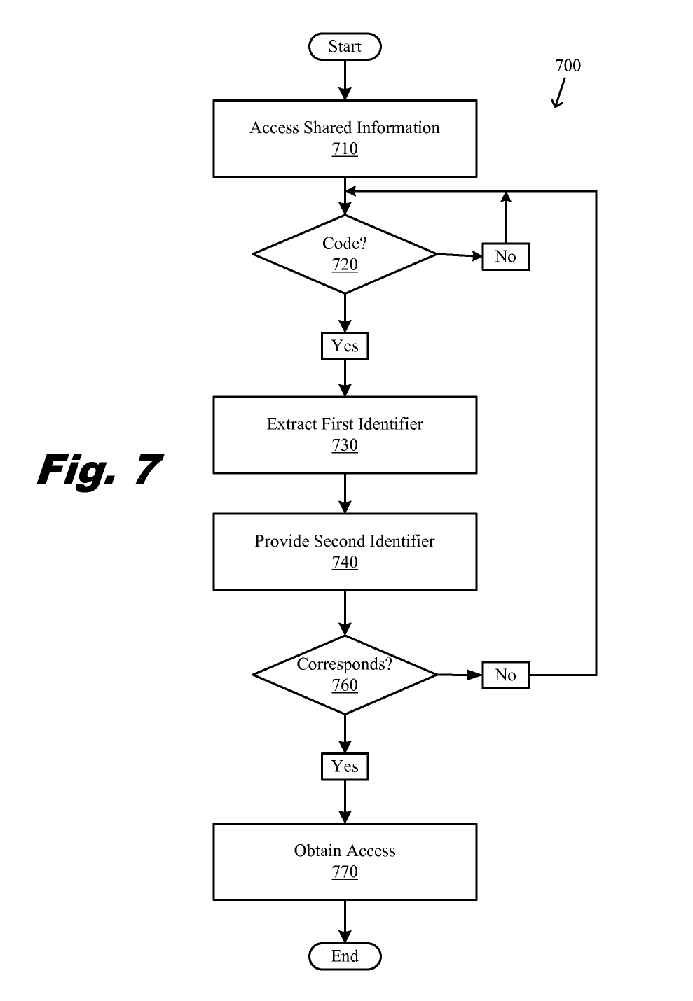

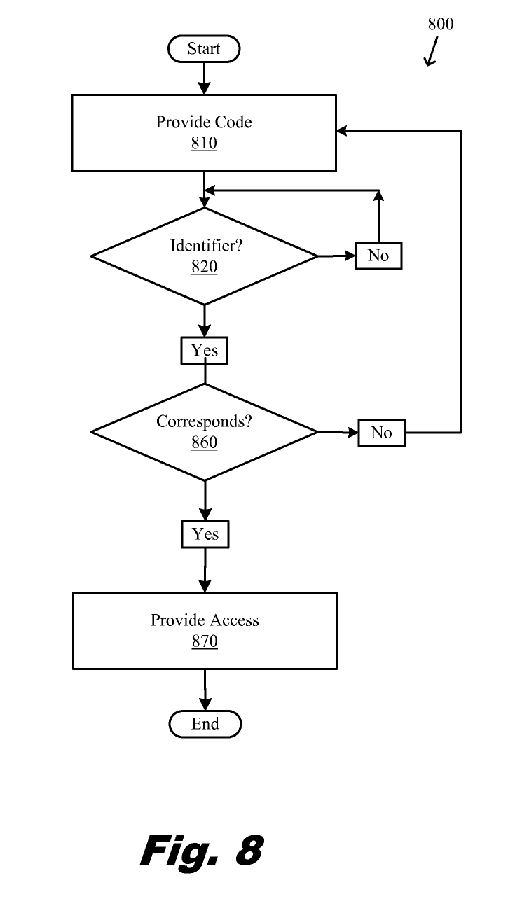

Although the operations depicted in FIGS. 7 and 8 are described with reference to a particular device performing them, i.e. the client device 620 or the display server 630, they are not intended to be restrictive to the particular device, but are merely exemplary in nature. Thus, the embodiments discussed may be performed by either the client device or the display server, or another device altogether.

Referring now to FIG. 8, an access control method 800 includes providing 810 a code, receiving 820 an identifier and providing 870 access if a corresponding 860 identifier is found.

Providing 810 a code may include providing a code that includes a first identifier. When a second identifier 820 is received and corresponds 860 to the first identifier, providing 870 access may be performed. Providing 870 access may include providing access of shared information to a the local device, which verifies the presence of the client device. These operations may be repeated as described in embodiments, as desired by the moderator, or in accordance with other procedures.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media may be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention may comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for obtaining access to a local device within an enclosed space, the system comprising:
an access server configured to control access to a local device;
a client device configured to obtain a code that is only accessible within an enclosed space, wherein the code contains a first identifier that is associated with the access server;
the client device further configured to provide a second identifier to the access server that corresponds to the first identifier and obtain access to a local device if access is enabled by the access server;
the access server further configured to provide the code that is only accessible within the enclosed space to the client device, wherein the code contains the first identifier that is associated with the access server;
the access server further configured to receive the second identifier from the client device and enable access to the local device if the second identifier corresponds to the first identifier.

2. The system of claim 1, wherein the access server is a display server.

3. The system of claim 1, wherein the code is selected from a group consisting of a visual encoding of binary information that is displayed in the enclosed space, an encoding within an RFID tag, an encrypted code, an image selected from a displayed plurality of images, an ordering of a plurality of images from a displayed plurality of images, an encoded broadcast from a light-based beacon, or an encoded broadcast from an infrared emitter.

4. A method for providing access to a local device within an enclosed space, the method comprising:
providing a code that is only accessible within an enclosed space to a client device, wherein the code contains a first unique identifier and wherein the enclosed space encloses the client device and a local device;
receiving a second identifier from the client device; and
enabling the client device to access the local device if the second identifier corresponds to the first identifier.

5. The method of claim 4, wherein the local device is a display device.

6. The method of claim 4, wherein the code is selected from a group consisting of a visual encoding of binary information that is displayed in the enclosed space, an encoding within an RFID tag, an encrypted code, an image selected from a displayed plurality of images, an ordering of a plurality of images from a displayed plurality of images, an encoded broadcast from a light-based beacon, an encoded broadcast from an infrared emitter, or a pen-based gesture.

7. The method of claim 6, wherein the pen-based gesture is made using a device that includes an accelerometer.

8. The method of claim 4, wherein an image of the code can be obtained by the local device.

9. The method of claim 8, wherein the first identifier can be obtained from the image of the code.

10. The method of claim 8, wherein the image is repeatably broadcast on a display within the enclosed space.

11. The method of claim 4, further comprising permitting an archival of shared information if the second identifier corresponds to the first identifier.

12. The method of claim 11, wherein permitting the archival of shared information comprises verifying that the local device is associated with a user specified in a list of known participants.

13. The method of claim 11, further comprising marking the shared information and permitting the archival after verifying that the local device is present within the enclosed space and that the mark is detected.

14. The method of claim 10, wherein a segment of the shared information that is archived can be referenced through an offset from an initial reference point of the shared information.

15. The method of claim 13, wherein the offset is selected from the group consisting of time elapsed from the beginning of the archive, a number of frames from the beginning of the archive or by some absolute time reference.

16. A method for obtaining access to a local device within an enclosed space, the method comprising:
obtaining a code that is only accessible within an enclosed space from an access server, wherein the code contains a first unique identifier and wherein the enclosed space encloses a local device and the access server;
providing a second identifier to the access server; and
obtaining access to the local device from the access server if the second identifier corresponds to the first identifier.

17. The method of claim 16, wherein the local device is a display device and the access server is a display server.

18. The method of claim 16, wherein the code is selected from a group consisting of a visual encoding of binary information that is displayed in the enclosed space, an encoding within an RFID tag, an encrypted code, an image selected from a displayed plurality of images, an ordering of a plurality of images from a displayed plurality of images, an encoded broadcast from a light-based beacon, or an encoded broadcast from an infrared emitter.

19. The method of claim 15, wherein an image of the code can be obtained by the client device.

20. The method of claim 19, wherein the image is repeatably broadcast on a display within the enclosed space.
